(19) United States
(12) Patent Application Publication
(10) Pub. No.: US 2007/0226292 A1
(43) Pub. Date: Sep. 27, 2007

(54) Method and apparatus for preserving updates to execution context when a request is fragmented and executed across process boundaries

(76) Inventors: Madhu K. Chetuparambil, Raleigh, NC (US); Srinivas Hasti, Raleigh, NC (US); Stephan Hesmer, Holzgerlingen (DE); Todd E. Kaplinger, Raleigh, NC (US); Subbarao Meduri, Apex, NC (US); Maxim A. Moldenhauer, Durham, NC (US); Aravind Srinivasan, Raleigh, NC (US)

Correspondence Address: IBM CORP. (RALEIGH SOFTWARE GROUP);c/o Rudolf O Siegesmund Gordon & Rees, LLP, 2100 Ross Avenue, Suite 2600, DALLAS, TX, 75201, US

(21) Appl. No.: 11/386,610

(22) Filed: Mar. 22, 2006

(51) Int. Cl. G06F 15/16

(52) U.S. Cl. 709/203; 709/230

(57) ABSTRACT

A Fragment Context Preserver has two components, a Fragmented Request Preserver and a Request Context Helper. The Fragmented Request Preserver program runs on a surrogate attached to a client computer and distributed computer environment, and a Request Context Helper runs on each application server on the distributed computer environment. Working together, these two programs ensure that independently dispatched fragments of a request execute with the required context.

### FIELD OF THE INVENTION

The invention relates generally to computer data processing, and particularly to ensuring that independently dispatched fragments of a request execute with the required context.

### BACKGROUND OF THE INVENTION

Clients use distributed computer environments to perform a variety of tasks across multiple applications. For a typical task, a client sends a request to a distributed computer environment, which returns a response to the client. While this seems simple enough, there are actually several intermediate steps involved in executing such a request. First, a user or an application initiates the client request by sending the request to a surrogate computer (hereafter “surrogate”), which is a computer that acts as an intermediary between the client and the distributed computer environment. The surrogate may perform such tasks as verifying the client's security credentials and determining which resource on the distributed computer environment is appropriate for executing the client's request. Second, the surrogate forwards the request to the appropriate resource on the client's behalf. Third, after the request executes on the resource, the response returns to the surrogate, which sends the response to the client.

Certain fragment markup and assembly technologies, such as EDGE SIDE INCLUDE (ESI), DELTA ENCODING, and other fragment markup and assembly engines allow for the fragmentation of requests under certain circumstances in the surrogates. Often, requests can be split into multiple smaller tasks, or “fetches” and distributed across multiple resources. After all the fetches are executed, the fragmented responses are reassembled and returned to the client. Fragmentation allows for more efficient use of resources and for lower cycle-times on a distributed computer environment. However the use of these technologies does not yield correct results when these fragments have to use context associated with the logical request. For example, consider the following scenario. A client makes a request which passes along attribute X. The request asks a first application(A) to set attribute Y, and then uses a second application(B) to perform a database lookup using both attributes X and Y. The request can be fragmented into two parts: “set Y” and “perform database look-up.” The first application that calculates Y associates this attribute with the request context, this context needs to be available when the code for the second application executes for the database look-up to succeed. As long as there is no fragmentation and the request executes sequentially in a single execution thread, the context is available to both the applications. If the fragments are dispatched independently to different execution environments from the surrogate, the context set by application A is not available to the fragment executing in Application B.

The Fragment may execute in the sequence defined by the logical application, but since the context is associated with the execution environment of the fragments and is lost after each fragment executes, the updates to the context are not available for proper execution of subsequent fragments.

### SUMMARY OF THE INVENTION

A Fragment Context Preserver ensures that independently dispatched fragments of a request execute with a required context. The Fragmented Context Preserver has two components, a Fragmented Request Preserver and a Request Context Helper. A Fragmented Request Preserver program runs on a surrogate attached to a client computer and distributed computer environment, and a Request Context Helper runs on each application server on the distributed computer environment. The Fragmented Request Preserver adds an attribute to each fragment of a request to indicate the beginning, middle and end of a logical request. When a client sends a request to a distributed computer environment, the Fragmented Request Preserver adds metadata to the request, indicating that it is a new logical request, then forwards the request to an application on a server in the distributed computer environment. If the application server chooses not to execute the entire request at once, the Request Context Helper at the application server will split the request into fragments and send the request fragments back to the surrogate as a “deferred response.” The deferred response may include a partial response to the initial request, such as setting an attribute needed to execute a subsequent fragment.

The Request Context Helper will embed any updates to the context in an opaque serialized form in the response. The updated context can be secured so that only authorized Request Context Helper can read the context. The Fragmented Request Preserver at the surrogate dispatches each fragment with any opaque updates received from prior fragment responses for the logical request in sequence and receives the responses for each fragment. The Request Context Helper at the application server securely retrieves any updates to the context that were sent with a fragment request, deserializes the updates and makes the context available in the execution environment prior to execution of the fragment. The Fragmented Request Preserver at the surrogate also adds metadata to the last fragment indicating that the sequence of fetches is over. This allows the Request Context Helper at the application server to release any resources held for the duration of the logical request. The Fragmented Request Preserver combines all the responses including cached fragments and forwards them to the client. By ensuring that the fragments have the updated context the Fragmented Request Preserver allows for fragmentation of requests that set and get attributes across multiple applications.

### BRIEF DESCRIPTION OF DRAWINGS

FIG. 1 depicts an exemplary computer network;

FIG. 2 depicts an exemplary memory on a computer containing the Fragment Context Preserver;

FIG. 3 depicts a flowchart of a Fragmented Request Preserver;

FIG. 4 depicts a flowchart of a Request Context Helper; and

FIG. 5 depicts a diagram of a fragmented request being dispatched in sequence.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Fragment Context Preserver.”

Additionally, the Fragment Context Preserver described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

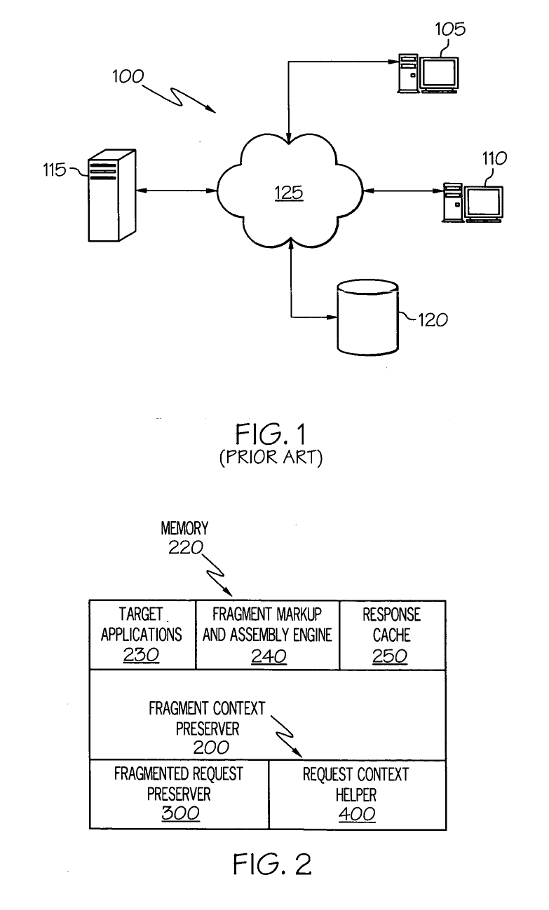

Fragment Context Preserver 200 typically is stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Thus, FIG. 2 is included merely as a descriptive expedient and does not necessarily reflect any particular physical embodiment of memory 220. As depicted in FIG. 2, though, memory 220 may include additional data and programs. Of particular import to Fragment Context Preserver 200, memory 220 may include target applications 230, Fragment Markup and Assembly Engine 240, and Response Cache 250 with which Fragment Context Preserver 200 interacts. Target Applications 230 perform tasks by responding to requests. Fragment Markup and Assembly Engine 240 fragments requests intended for Target Applications 230. Fragment Markup and Assembly Engine may be an ESI engine. Response Cache 250 is a temporary storage for responses to dispatched fragments. Fragment Context Preserver 200 two components: Fragmented Request Preserver 300 and Request Context Helper 400. The Fragmented Request Preserver 300 in this example operates on a surrogate computer responsible for propagating requests to network 100. Request Context Helper 400 operates on an application server in conjunction with Fragment Markup and Assembly Engine 240 and Target Applications 230.

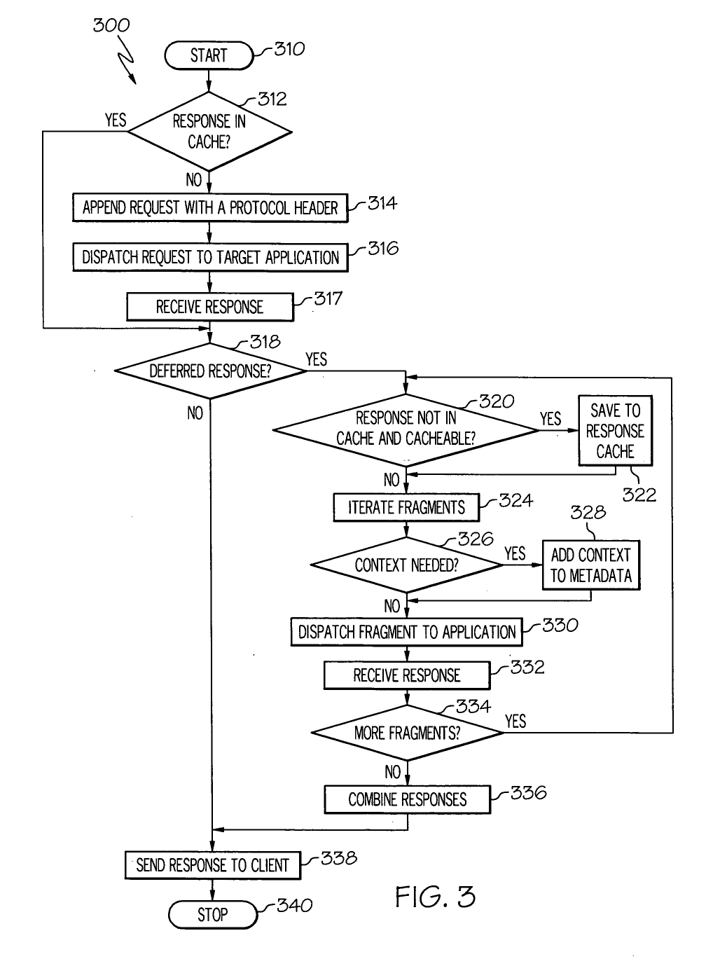

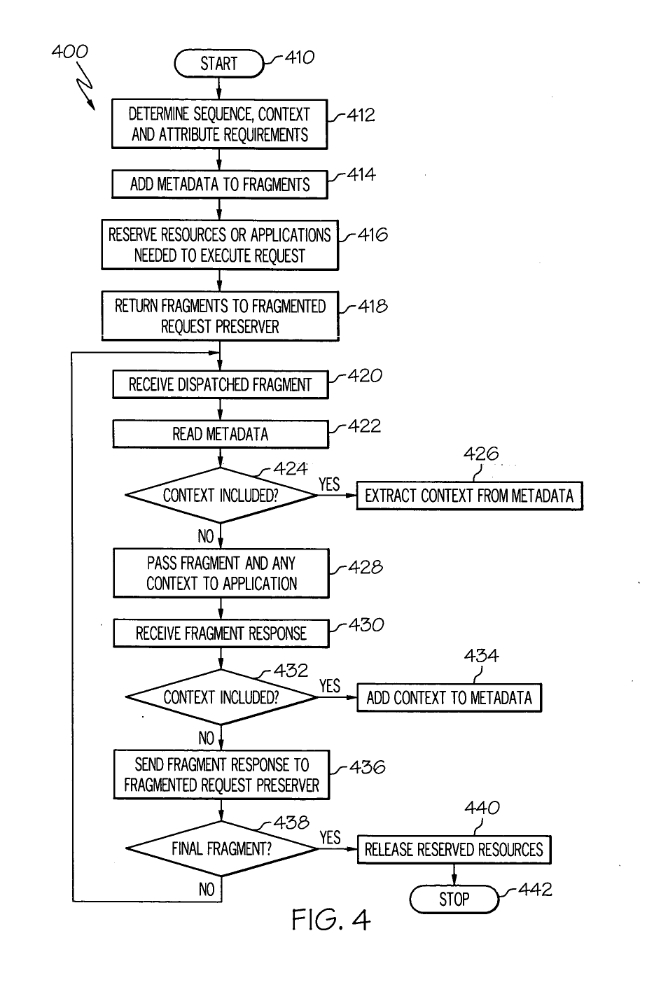

FIG. 3 is a flowchart depicting the logic of Fragmented Request Preserver 300. Fragmented Request Preserver 300 starts when an initial request is made by a client (310). A determination is made whether a response is in response cache 250 (312). If so, Fragmented Request Preserver goes to step 318, and if not, appends the initial request with a metadata protocol header (314). The purpose for this determination is to take advantage of information saved in response cache 250 from a previous logical request and that can be used to respond to the current logical request, thereby bypassing the need to actually execute the request on the application. The protocol header initializes the context propagation. Fragmented Request Preserver 300 dispatches the initial request to target applications 230 (316). Fragmented Request Preserver 300 receives a response to the initial request (317), and determines if target applications 230 made a normal response or a deferred response (318). A normal response is sent to the client (338) and Fragmented Request Preserver 300 ends (340). By making the determination at step 318 the decision by the Fragment Markup and Assembly Engine to split the initial request is bypassed and automatically uses eligible responses in the response cache. A deferred response occurs when Fragment Markup and Assembly Engine 240 splits the initial request into a sequence of fragments. Fragment Context Helper 400 appends each fragment with metadata protocol headers specifying sequence information (see FIG. 4). Additional metadata provided by Fragment Context Helper 400 indicates whether each fragment requires specific attributes or contexts in order to execute properly. An attribute sent as a response to a fragment can be appended as a context when dispatching a subsequent fragment. In the case of a deferred response, target applications 230 may execute one or more fragments as part of the response, such as setting an initial attribute.

If at step 318, a determination is made that a response is a deferred response, Fragmented Request Preserver 300 determines whether the response is not in response cache 250 and is cacheable (320). In other words, some responses, referred to as eligble responses, are cacheable and are cached along with their context metadata, and this step is different from temporarily storing fragment responses until they are aggregated with the scope of a logical request. The reason for this determination is to set two conditions that must be satisfied before a response can be saved to the response cache as an eligible response. First, the same response must not be previously saved to the response cache, and the response must be capable of being saved. These conditions prevent duplicate response from being save in the response cache, and prevents attempts at saving responses that cannot be saved. An example of a response that cannot be saved is a command rather than discrete data. It the response is cacheable, Fragmented Request Preserver 300 saves any initial response information, such as attributes, to response cache 250 (322). If the response is not cacheable, Fragmented Request Preserver 300 iterates through fragments in sequence, using the sequencing and context information in the metadata protocol headers (324).

If an attribute or context needs to be added to a fragment (326), Fragmented Request Preserver 300 adds the context (328), which may have been saved in response cache 250, before dispatching the fragment to target applications 230 (330). In other words, Fragmented Request Preserver adds metadata referencing updates to context from previous fragment fetches within the scope of the logical request. In addition to adding attributes and contexts, Fragmented Request Preserver 300 may add other information to the metadata protocol header, such as terminating context propagation with the final fragment. Fragmented Request Preserver 300 receives the response from target applications 230 (332) and determines whether there are more fragments left to dispatch (334). If there are more fragments, Fragmented Request Preserver 300 goes to step 320, and if not, (the final fragment has been dispatched) combines all the responses stored in response cache 250 (336), sends the combined response to the client (338), and stops (340).

FIG. 4 is a flowchart depicting the logic of Request Context Helper 400. Request Context Helper 400 starts when Fragment Markup and Assembly Engine 240 breaks a request up into fragments (410). Request Context Helper 400 determines the sequence, context and attribute requirements of the fragments (412), adds metadata to the fragments (414), reserves the resources or applications necessary to execute the request (416), and returns the fragments to Fragmented Request Preserver 300 (see FIG. 3) (418). Next, Request Context Helper 400 receives a dispatched fragment from Fragmented Request Preserver 300 (420), reads the metadata for the dispatched fragment (422), and determines whether context is included in the fragment (424). If context is included, Request Context Helper 400 extracts context from the metadata (426), and goes to step 428. If context is not included, Request Context Helper 400 goes to step 428 where it passes the fragment and context to the application (428). Next, Request Context Helper 400 receives a fragment response from the application (430) and determines whether context is included (432). If so, it adds context to the metadata (434) and goes to step 436. If context was not included, Request Context Helper 400 goes to step 436 where it sends a fragment response to Fragmented Request Preserver 300. Request Context Helper 400 determines whether the fragment is a final fragment (438), and if not, goes to step 420. If the fragment is a final fragment, Request Context Helper 400 releases reserved resources (440) and stops (442).

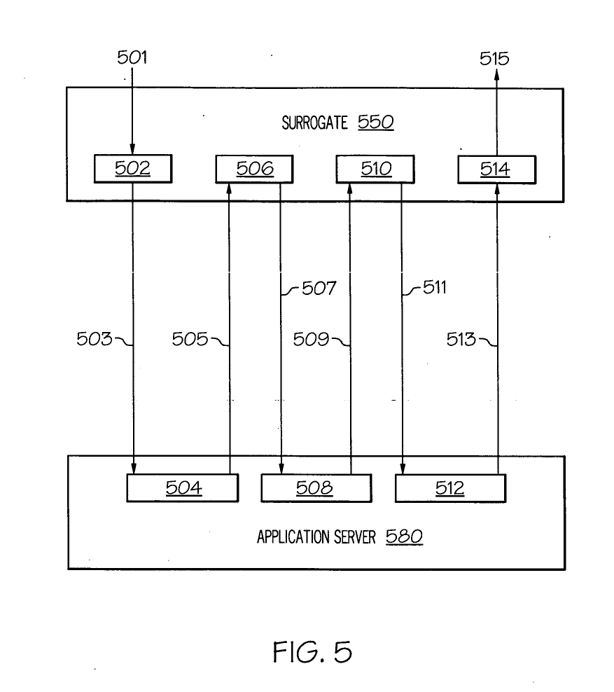

FIG. 5 depicts propagation of a fragmented request. Numeral 501 represents an initial request made by a client. Numeral 502 represents a Fragmented Request Preserver 300 running on Surrogate 550 that appends the initial request with a metadata protocol header to initialize the context propagation. Numeral 503 represents surrogate 550 dispatching the initial request to target application server 580 (504). Fragment Markup and Assembly Engine 240 on application server 580 splits the initial request into two fragments. Each fragment has metadata protocol headers with sequencing information. The application also sets an initial attribute “X”. Numeral 505 represents a deferred response containing the two request fragments and the attribute “X” is sent back to Surrogate 550. Numeral 506 represents Surrogate 550 saving the attribute to response cache 250.

Numeral 507 represents Surrogate 550 dispatching fragment 1 with attribute X to application server 580. Numerical 508 represents application server 420 setting attribute “Y” in response to the fragment 1 and attribute X. Numeral 509 represents application server 580 sending the response with attributes X and Y to Surrogate 550. Numeral 510 represents Surrogate 550 receiving the response and saving the response to response cache 250. Numeral 511 represents Surrogate 550 dispatching fragment 2 with attributes X and Y to application server 580. Fragment 2 also contains metadata protocol header information to terminate context propagation. Numeral 512 represents application server 580 performing required actions using attributes X and Y in response to fragment 2. Numeral 513 represents application server 580 sending the final response to Surrogate 550. Numeral 514 represents surrogate 550 receiving the response and combining the response with the previous responses in response cache 250. Numeral 515 represents surrogate 550 sending the combined response to the client.

In an embodiment, the Fragment Context Preserver can increase communication security and efficiency of the distributed computer environment by only including the least amount of relevant metadata related to sequence and attributes and by encoding and decoding the information contained in the metadata.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for ensuring the fragments of a fragmented request execute in the proper sequence, the computer implemented process comprising:
receiving a request from a client;
adding a metadata protocol header to the request initializing context propagation;
forwarding the request to an application;
receiving a deferred response from the application, wherein the deferred response includes more than one request fragment and each fragment contains a metadata protocol header indicating the proper execution sequence;
dispatching each fragment to an application in the proper sequence;
adding a metadata protocol header to the final fragment terminating context propagation;
add a metadata referencing updates to a context from a previous fragment fetch within the scope of the request;
receiving responses from the application for each fragment;
combining the responses; and
sending the combined response to the client.

2. The computer implemented process of claim 1 further comprising storing eligible responses from the application for each fragment in a cache.

3. The computer implemented process of claim 2, further comprising extracting a required attribute for executing a fragment from the cached response of a previously executed fragment.

4. The computer implemented process of claim 3, further comprising adding metadata to the fragment with the required attribute before dispatching the fragment.

5. The computer implemented process of claim 2 wherein the process is secured and optimized by only including relevant sequence information and attributes in the metadata.

6. A computer program product for ensuring the fragments of a fragmented request execute in the proper sequence, the computer program product comprising:
instructions for causing a surrogate to perform the actions:
receive a request from a client;
add a metadata protocol header to the request initializing context propagation;
forward the request to an application;
receive a deferred response from the application, wherein the deferred response includes more than one request fragment and each fragment contains a metadata protocol header indicating the proper execution sequence;
dispatch each fragment to an application in the proper sequence;
add a metadata protocol header to the final fragment terminating context propagation;
add a metadata referencing updates to a context from a previous fragment fetch within the scope of the request;
receive responses from the application for each fragment;
combine the responses;
send the combined response to the client;

7. The computer program product of claim 6 further comprising storing eligible responses from the application for each fragment in a cache.

8. The computer program product of claim 7, further comprising extracting a required attribute for executing a fragment from the cached response of a previously executed fragment.

9. The computer program product of claim 8, further comprising adding metadata to the fragment with the required attribute before dispatching the fragment.

10. The computer program product of claim 7 wherein the process is secured and optimized by only including relevant sequence information and attributes in the metadata.

11. A system for ensuring the fragments of a fragmented request execute in the proper sequence comprising:
a network connecting a plurality of computers;
a computer connected to the network and to a memory containing a program, the program directing the processor to:
receive a request from a client;
add a metadata protocol header to the request initializing context propagation;
forward the request to an application;
receive a deferred response from the application, wherein the deferred response includes more than one request fragment and each fragment contains a metadata protocol header indicating the proper execution sequence;
dispatch each fragment to an application in the proper sequence;
add a metadata protocol header to the final fragment terminating context propagation;
add a metadata referencing updates to a context from a previous fragment fetch within the scope of the request;
receive responses from the application for each fragment;
combine the responses; and
send the combined response to the client.

12. The computer of claim 11 wherein the program further directs the computer to store eligible responses from the application for each fragment in a cache.

13. The computer of claim 12 wherein the program further directs the computer to extract a required attribute for executing a fragment from the cached response of a previously executed fragment.

14. The computer of claim 13, wherein the program further directs the computer to add metadata to the fragment with the required attribute before dispatching the fragment.

15. The computer of claim 12 wherein the program further directs the computer to secure and optimize by only including relevant sequence information and attributes in the metadata.
